(19) United States
(12) Patent Application Publication
(10) Pub. No.: US 2014/0111797 A1
(43) Pub. Date: Apr. 24, 2014

(54) SUBSTRATE ORIENTER CHAMBER

(71) Applicant: APPLIED MATERIALS, INC., Santa Clara, CA (US)

(72) Inventors: SHIN KITAMURA, Chiba-ken (JP); YUJI AOKI, Yokohama-shi (JP)

(73) Assignee: APPLIED MATERIALS, INC., Santa Clara, CA (US)

(21) Appl. No.: 14/046,439

(22) Filed: Oct. 4, 2013

Related U.S. Application Data
(60) Provisional application No. 61/716,114, filed on Oct. 19, 2012.

(51) Int. Cl. G01B 11/26

(52) U.S. Cl. CPC G01B 11/26
USPC 356/138

(57) ABSTRACT

Orienter chambers for determining the orientation of a substrate in a substrate processing system are provided. In some embodiments, an orienter chamber includes a housing enclosing an interior volume; a rotatable stage disposed inside the housing including a substrate support surface adapted to support a substrate; a light source disposed above the stage and positioned to provide illuminating light to the outer circumference of a substrate when the substrate is loaded on the rotatable stage, wherein the illuminating light from the light source is inclined toward the center of the substrate by an angle from a vertical line that extends perpendicular to the substrate support surface; a light-receiving unit having a light-receiving surface on which are arranged a plurality of light-receiving elements that receive the illuminating light from the light source; and an analysis unit that analyzes the illuminating light received by the light-receiving elements.

### CROSS-REFERENCE TO RELATED APPLICATIONS

This application claims benefit of U.S. provisional patent application Ser. No. 61/716,114, filed Oct. 19, 2012, which is herein incorporated by reference.

### FIELD

Embodiments of the present invention generally relate to semiconductor processing apparatus.

### BACKGROUND

Multi-chamber semiconductor manufacturing systems in which multiple chambers are integrated are being used in processing of substrates to manufacture semiconductor devices. In a multi-chamber manufacturing system a substrate is transported between associated chambers with a transport robot. The system may include an orienter chamber that receives the substrate on a rotatable stage from the robot and detects the position and orientation of the substrate on the stage in order to facilitate placement of the substrate in subsequent chambers within processing parameters.

Some orienter chambers use a light source and a light receiving unit for edge detection of the substrate. The light source illuminates a portion of the outer circumference of a substrate. Some of the light is blocked by the substrate and does not reach the light receiving unit, which is recognized as a shadow zone. Light that does reach the light receiving unit is recognized as a transmission zone. As the substrate rotates through one revolution, an analysis unit analyzes the change in position of the shadow zone on the light receiving unit and determines orientation and eccentricity based on this change.

However, the inventors have observed that the shadow zone and transmission zone cannot be definitively identified with some conventional orienter chambers.

Accordingly, the inventors have provided an improved apparatus and method for substrate detection in a substrate orienter chamber.

### SUMMARY

Orienter chambers for determining the orientation of a substrate in a substrate processing system are provided. In some embodiments, an orienter chamber includes a housing enclosing an interior volume; a rotatable stage disposed inside the housing including a substrate support surface adapted to support a substrate; a light source disposed above the stage and positioned to provide illuminating light to the outer circumference of a substrate when the substrate is loaded on the rotatable stage, wherein the illuminating light from the light source is inclined toward the center of the substrate by an angle from a vertical line that extends perpendicular to the substrate support surface; a light-receiving unit having a light-receiving surface on which are arranged a plurality of light-receiving elements that receive the illuminating light from the light source; and an analysis unit that analyzes the illuminating light received by the light-receiving elements.

In some embodiments, an orienter chamber includes a housing enclosing an interior volume; a rotatable stage disposed inside the housing including a substrate support surface adapted to support a substrate; a laser light source disposed above the stage and positioned to provide illuminating light to an outer circumference of a substrate when the substrate is loaded on the rotatable stage, wherein the illuminating light from the light source is inclined toward a center of the substrate by an angle of about 55° to about 75° from a vertical line that extends perpendicular to the substrate support surface; a light-receiving unit having a light-receiving surface on which are arranged a plurality of charge coupled device light-receiving elements that receive the illuminating light from the light source; and an analysis unit that analyzes the illuminating light received by the light-receiving elements.

In some embodiments, a method of use of an orienter chamber includes supporting a substrate on a substrate support surface; providing illuminating light inclined at an angle between about 55° and about 75° from a vertical line to an outer circumference of the substrate; rotating the substrate support with the substrate supported thereon for at least one revolution; receiving light scattered by the outer circumference of the substrate on a light receiving surface of a light receiving unit; recognizing the received scattered light as a shadow zone; sending a change in position of the shadow zone to an analysis unit; analyzing the change in position of the shadow zone; and determining the orientation and eccentricity of the substrate based on the change of position of the shadow zone.

Other embodiments and variations are described in more detail, below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 is a cross section schematic that depicts an overview of an orienter chamber in accordance with some embodiments of the present invention.

FIG. 2A depicts the results of detecting the outer circumference of a transparent substrate with a conventional orienter chamber.

FIG. 2B depicts the results of detecting the outer circumference of a transparent substrate with an orienter chamber in accordance with some embodiments of the present invention.

FIG. 2C depicts the results of detecting the outer circumference of a transparent substrate with an orienter chamber in accordance with some embodiments of the present invention.

FIG. 2D depicts the results of detecting the outer circumference of a transparent substrate with an orienter chamber in accordance with some embodiments of the present invention.

FIG. 3 is a cross section schematic that depicts an overview of an orienter chamber in accordance with some embodiments of the present invention.

FIG. 4 is a plan view of a semiconductor manufacturing system in which the orienter chamber of the present invention may be used.

FIG. 5 is a cross section that shows an overview of a conventional orienter chamber.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

The present invention relates to a method and apparatus for detecting the position of a substrate on a stage in an orienter chamber. Embodiments of the present invention are explained below in reference to Figures.

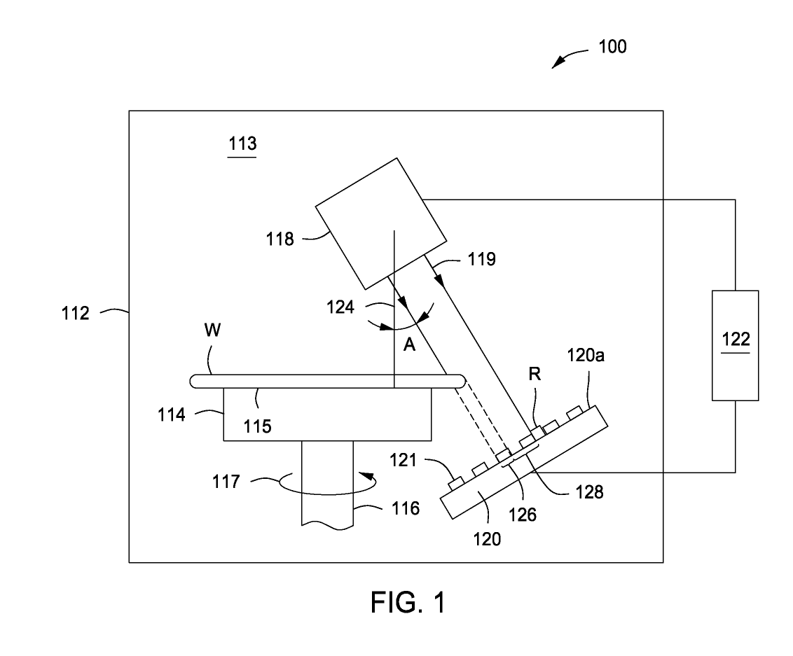

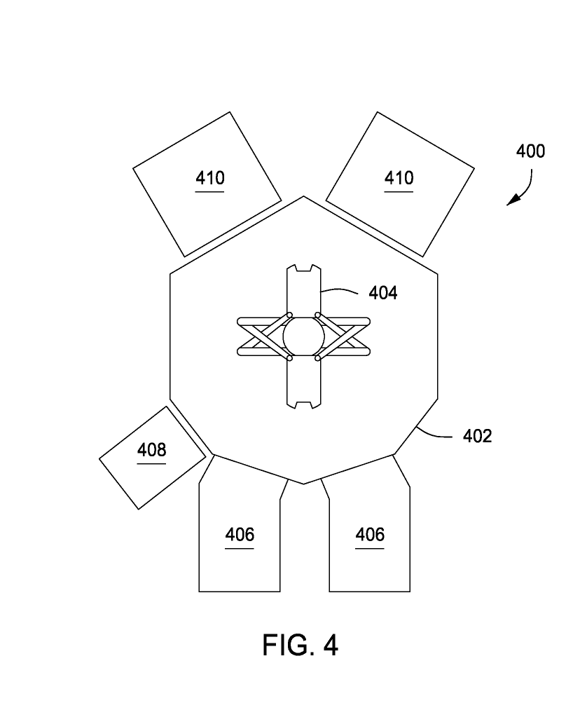

FIG. 1 shows an embodiment of an orienter chamber 100 in accordance with embodiments of the present invention. Orienter chamber 100 is used as a chamber that constitutes the semiconductor manufacturing system 400 shown in FIG. 4, for example.

In FIG. 1, according to some embodiments of the present invention, orienter chamber 100 comprises a housing 112 enclosing an interior volume 113, which may be held in a vacuum state. The housing 112 may be formed from a metal, in a non-limiting example, from aluminum. A disk-shaped, rotatable stage, stage 114, is disposed horizontally inside the housing 112, and is configured to support a substrate W, e.g., a transparent substrate, on a substrate support surface 115. A rotary shaft 116 is joined to the center of the underside of the stage 114, and the stage 114 can be rotated in the direction of the arrow 117.

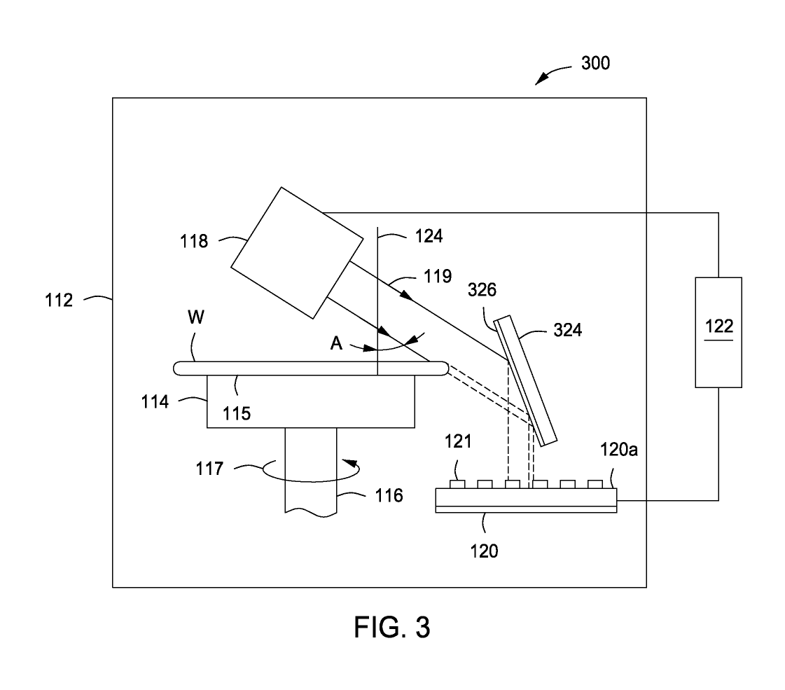

Above stage 114 within the housing 112 is provided a light source 118 positioned to provide illuminating light (light depicted by arrows 119) to the outer circumference of the substrate W. The light source 118 may be, in a non-limiting example, a laser light source that emits light with a wavelength of, for example, about 650 nm. The light emitted from light source 118 is inclined at a prescribed angle of inclination A toward the center of the aforementioned substrate from a vertical line 124 that extends upward from the outer circumference of the substrate (i.e., perpendicular to the substrate support surface 115) as shown in FIGS. 1 and 3. In some embodiments, the angle of inclination A is about 55° to about 75°, or about 60° to about 70°.

Below stage 114 in housing 112 is provided a light-receiving unit 120 that receives the light from light source 118 that illuminates the outer circumference of substrate W. Light-receiving surface 120a of light-receiving unit 120 is disposed to form a 90° angle, right angle R, with the light depicted by arrows 119 from the light source 118. A plurality of light-receiving elements 121 (for example charge coupled device (CCD) elements) are arranged on the light-receiving surface 120a of light-receiving unit 120, and whether or not light is received can be determined at any position on light-receiving surface 120a.

Orienter chamber 100 is also provided with an analysis unit 122 that analyzes the light received by light-receiving unit 120 in order to analyze the orientation and position of substrate Won stage 114.

The operation of aforementioned orienter chamber 100 is further explained below with reference to the Figures.

FIG. 4 shows an example of a semiconductor manufacturing system 400 in which an orienter chamber 408 of the present invention may be used. The semiconductor manufacturing system 400 is provided with a transport chamber 402 that transports semiconductor substrates W to each chamber with a transport robot 404 that is provided inside the transport chamber 402. The transport chamber may be maintained in a vacuum state. A load-lock chamber 406 is provided in which the pressure inside the load lock chamber 406 is changed from an atmospheric state to a vacuum state in order to transport the semiconductor wafers into transport chamber 402, an orienter chamber 408 that detects and adjusts the position and orientation of the semiconductor wafers loaded onto transport robot 404, and a process chamber 410 that performs the prescribed processing, for example, film formation using physical vapor deposition (PVD) or chemical vapor deposition (CVD), etching, or other processing on the semiconductor substrates.

In a semiconductor manufacturing system, for example the semiconductor manufacturing system 400 shown in FIG. 4, a substrate W is transported from load-lock chamber 406 to orienter chamber 408 by transport robot 404. Substrate W is loaded onto the stage 114 (FIG. 1) and the stage 114 is then rotated such that the outer circumference of semiconductor substrate W is illuminated with light from light source 118. The light from light source 118 that reaches the outer circumference of substrate W is reflected and scattered by the outer circumference of substrate W and is received on light-receiving surface 120a. This light is recognized as a shadow zone 126 by light-receiving unit 120. The light from the light source 118 that passes outside of the substrate W is received on light-receiving surface 120a unchanged (i.e., not reflected or scattered), and this light is recognized as a transmission zone 128 by light-receiving unit 120.

The outer circumference of the substrate W may be provided with a flat face (orientation flat section) or notches (notched section) to facilitate determining the orientation of the substrate W. A change in the shape of the outer circumference of substrate W (the orientation flat section or notched section, for example) or any eccentricity by the substrate W appears as a change in the position where the shadow zone 126 is produced on the light-receiving unit 120. For example, if the substrate W is off-center (when the center of the substrate W and the center of rotation of the stage 114 are not aligned), when the substrate W rotates on the stage 114, the position where the shadow zone 126 occurs on the light-receiving surface 120a changes.

Illumination of the substrate W by the light from light source 118 is performed until the substrate W makes a minimum of one revolution. Information related to the shadow zone 126 and transmission zone 128 that is received by light-receiving unit 120 is sent to analysis unit 122, where it may be saved and analyzed. The analysis unit 122 determines the orientation and eccentricity of substrate W based on the change of the shadow zone 126 and transmission zone 128. It is thereby possible for substrate W to be loaded in the desired position and orientation on transport robot 404 by adjusting the operation of transport robot 404 when substrate W is collected from orienter chamber 408.

With orienter chamber 100 in accordance with the present invention, the light that is emitted from light source 118 is inclined toward the center of the aforementioned substrate from a vertical line 124 that extends upward from the outer circumference of the substrate W, so the shadow zone 126 formed at the outer circumference of substrate W is formed to be longer on light-receiving surface 120a. It is thereby possible to more definitively determine the outer circumference of substrate W.

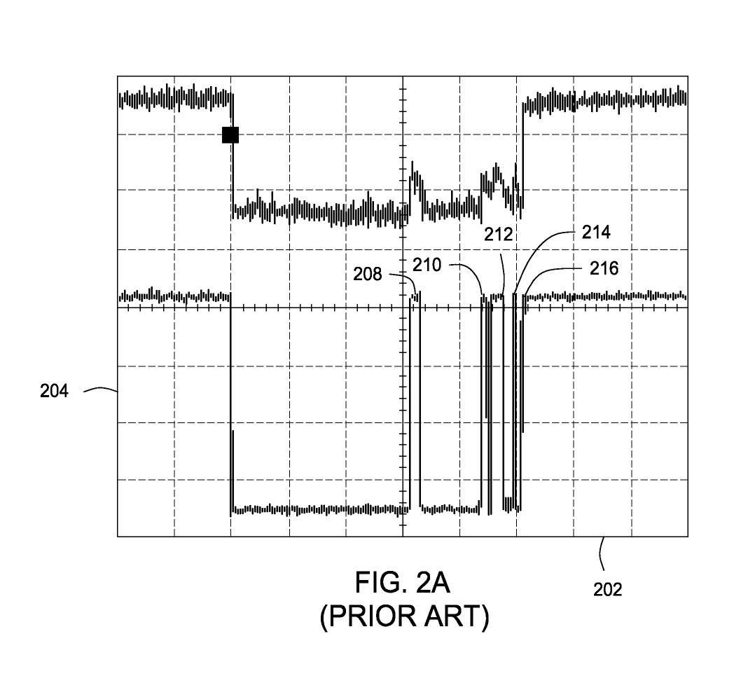

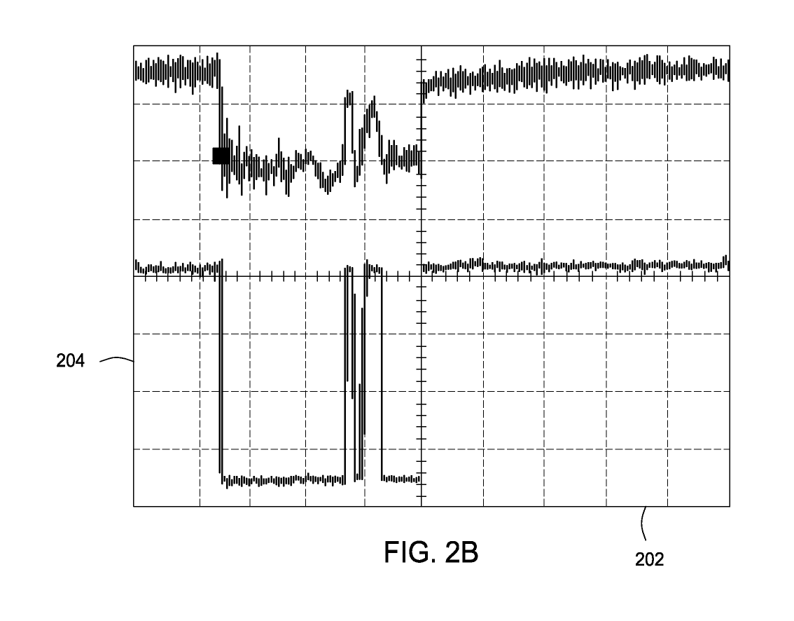

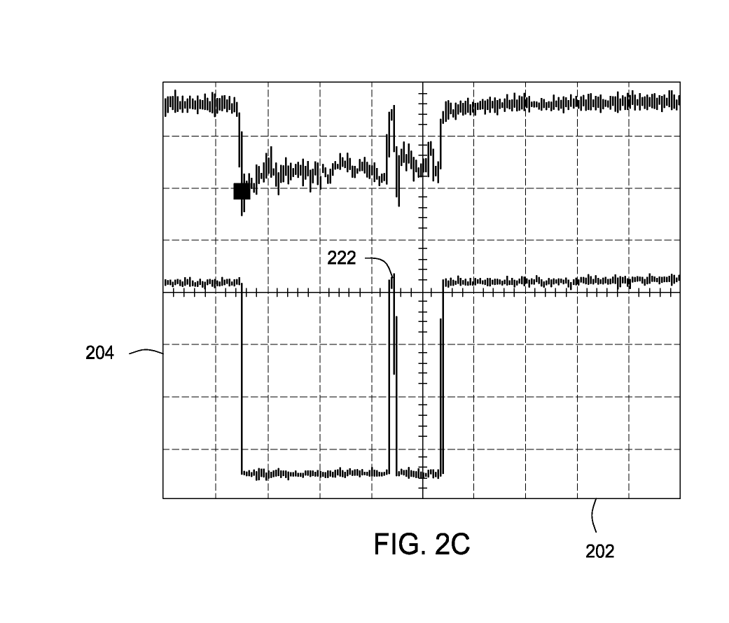

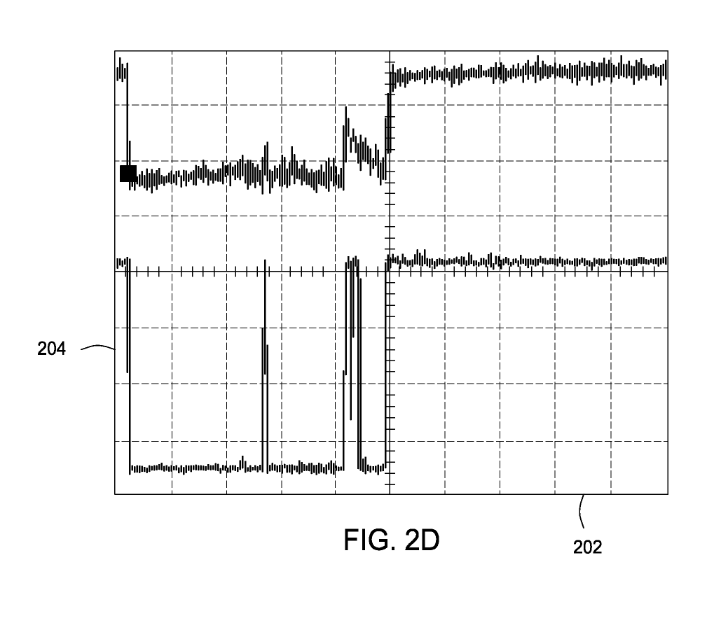

The present invention is next explained in more detail with an application example. FIG. 2A graphically shows the results of processing transparent substrates, such as substrate W, with a conventional orienter chamber. Some conventional orienter chambers, for example orienter chamber 508, include a stage 514 to support a wafer W within a housing 512. The stage 514 is supported for rotation (as indicated by arrow 517) on a shaft 516. A light source 518 illuminates a peripheral portion of the substrate W. Information related to a shadow zone and transmission zone received by a light receiving unit 520 is sent to an analysis unit 522.

FIGS. 2B-2D graphically depict the results of processing transparent substrates, such as substrate W, with the orienter chamber 100 of the present invention. In FIGS. 2A-2D, the horizontal axis 202 represents the coordinate values on the light-receiving surface 120a of the light-receiving unit 120. The vertical axis 204 represents the light-reception state of the light-receiving elements 121 at each coordinate position. The vertical axis 204 has scale such that when the amount of light received by the light-receiving elements 121 is small, the graphical representation (i.e., data point) is shown distanced further from the horizontal axis 202 than the graphical representation associated with a large amount of light received by the light-receiving elements 121. The upper graphical representation in each figure indicates data that were actually measured, and the lower level shows results that indicate whether the individual light-receiving elements 121 actually received light by applying threshold value processing. In FIGS. 2A-2D, a point at which the light-receiving elements 121 change from receiving light to not receiving light indicates the outer circumference of the substrate W.

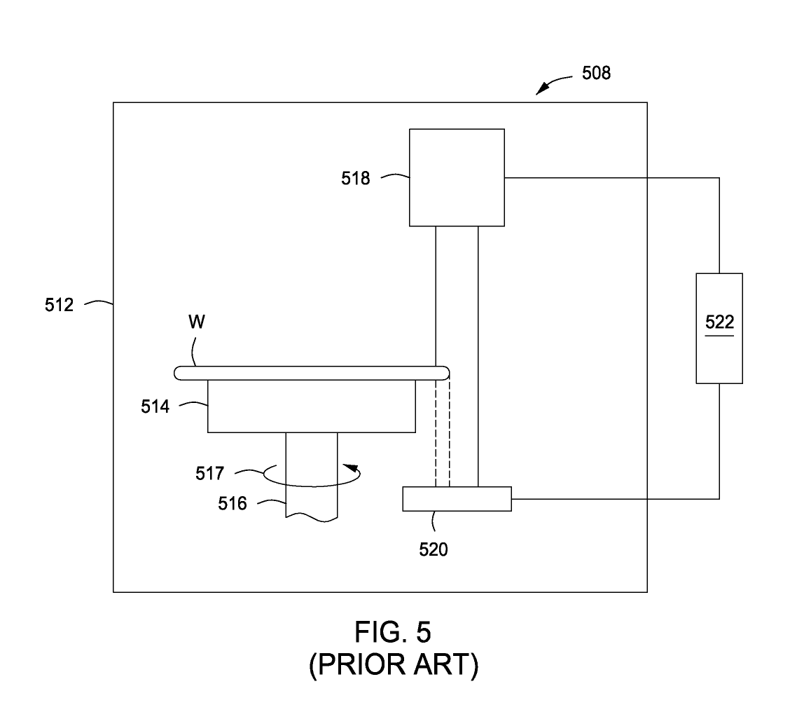

FIG. 2A shows a case when the outer circumference of a substrate W is illuminated with light emitted from the light source at an angle of 90° (a conventional orienter chamber) as in FIG. 5. FIGS. 2B-2D show cases when the light emitted from the light source is inclined at an angle A of 55°, 65°, and 75°, respectively, toward the center of the aforementioned substrate W from a vertical line 124 that extends upward from the outer circumference of the substrate W in accordance with some embodiments of the present invention and illustrated in FIG. 1

In FIG. 2A, points at which the light-receiving elements 121 change from receiving not receiving light to receiving light are detected at multiple locations, for example 208, 210, 212, 214, and 216. The multiple transitions from not receiving light to receiving light make detecting the shadow zone 126 more difficult. In contrast to this, in FIGS. 2B-2D, this situation is improved. Particularly in FIG. 2C where the light is inclined at an angle A of 65°, the transition from not receiving light to receiving, corresponding to a shadow zone 126 (FIG. 1), is detected only at one location 222, beneficially affecting the detection of the shadow zone 126.

FIG. 3 depicts an embodiment of an orienter chamber 300 in accordance with the present invention. In the explanation below, the same reference symbols are used concerning the configuration of the orienter chamber 100 described above, and their detailed explanation is omitted.

As presented in FIG. 3, orienter chamber 300 comprises a reflective member 324 for reflecting the light from light source 118 (represented by arrows 119) by which the outer circumference of semiconductor substrate W is illuminated. The reflective member 324 is positioned to reflect the light onto light-receiving unit 120 that is disposed horizontally below the stage 114. Reflective member 324 may comprise a reflecting sheet, reflecting layer 326, that may be formed from the same metal material used for the inside of the housing (aluminum, for a non-limiting example). It is also possible to use a vacuum chamber mirror wherein a vapor deposited aluminum layer and a silicon oxide layer are successively deposited onto a quartz substrate.

With the orienter chamber 300 in in the illustrative embodiment, the light emitted from the light source 118 that is inclined is reflected by the reflective member 324 onto the horizontally disposed light-receiving unit 120 that is disposed horizontally, so the effects achieved are that the alignment of the individual members, for example stage 114, light source 118, and light-receiving unit 120, is facilitated, and economy of space with the chamber may be achieved.

Embodiments of the orienter chamber described herein may improve identification of the shadow zone of a wafer, for example, transparent wafers, thus overcoming the problem described above. As recited above, with the orienter chamber of the present invention, the light that is emitted from the light source is inclined toward the center of the aforementioned substrate from a vertical line that extends upward from the outer circumference of the substrate, so the shadow zone formed by the outer circumference of substrate W can be projected to be longer at the light-receiving surface. It is thereby possible to more definitively determine the outer circumference of a transparent substrate.

While the foregoing is directed to embodiments of the present invention, other and further embodiments of the invention may be devised without departing from the basic scope thereof.

1. An orienter chamber, comprising:
a housing enclosing an interior volume;
a rotatable stage disposed inside the housing including a substrate support surface adapted to support a substrate;
a light source disposed above the stage and positioned to provide illuminating light to an outer circumference of a substrate when the substrate is loaded on the rotatable stage, wherein the illuminating light from the light source is inclined toward a center of the substrate by an angle from a vertical line that extends perpendicular to the substrate support surface;
a light-receiving unit having a light-receiving surface on which are arranged a plurality of light-receiving elements that receive the illuminating light from the light source; and
an analysis unit that analyzes the illuminating light received by the light-receiving elements.

2. The orienter chamber of claim 1, wherein the light receiving unit receives light scattered by an outer circumference of a substrate supported and rotated on the stage and receives light that passes outside of the substrate.

3. The orienter chamber of claim 2, wherein the light receiving unit is configured to recognize the received scattered light as a shadow zone.

4. The orienter chamber of claim 3, wherein the stage can rotate the substrate at minimum one revolution such that an eccentricity of the substrate appears as a change in position of the shadow zone on the light receiving unit.

5. The orienter chamber of claim 4, wherein the change in position is sent to the analysis unit in order to analyze the position of the substrate on the stage.

6. The orienter chamber of claim 1, wherein the angle is about 55° to about 75°.

7. The orienter chamber of claim 1, wherein the light source is a laser.

8. The orienter chamber of claim 7, wherein the laser has a wavelength of about 650 nanometers.

9. The orienter chamber of claim 1, wherein the light-receiving elements are charge coupled devices.

10. The orienter chamber of claim 1, wherein the light-receiving surface is disposed to form a 90° angle with the illuminating light.

11. The orienter chamber of claim 1, further comprising:
a reflective member disposed inside the housing and positioned to reflect the illuminating light onto the light-receiving surface of the light-receiving unit.

12. The orienter chamber of claim 11, wherein the light receiving unit is disposed horizontally.

13. The orienter chamber of claim 11, wherein the inside of the housing is formed from metal.

14. The orienter chamber of claim 13, wherein the reflective member is formed from the same metal used for the inside of the housing.

15. An orienter chamber, comprising:
a housing enclosing an interior volume;
a rotatable stage disposed inside the housing including a substrate support surface adapted to support a substrate;
a laser light source disposed above the stage and positioned to provide illuminating light to an outer circumference of a substrate when the substrate is loaded on the rotatable stage, wherein the illuminating light from the light source is inclined toward a center of the substrate by an angle of about 55° to about 75° from a vertical line that extends perpendicular to the substrate support surface;
a light-receiving unit having a light-receiving surface on which are arranged a plurality of charge coupled device light-receiving elements that receive the illuminating light from the light source; and
an analysis unit that analyzes the illuminating light received by the light-receiving elements.

16. The orienter chamber of claim 15, wherein the light receiving surface is arranged at a 90 ° angle to the illuminating light.

17. The orienter chamber of claim 15, further comprising a reflective member disposed inside the housing to reflect the illumination light onto the light receiving surface, wherein the light receiving surface is disposed horizontally.

18. A method of use for an orienter chamber comprising:
supporting a substrate on a substrate support surface;
providing illuminating light inclined at an angle between about 55° and about 75° from a vertical line to an outer circumference of the substrate;
rotating the substrate support with the substrate supported thereon for at least one revolution;
receiving light scattered by the outer circumference of the substrate on a light receiving surface of a light receiving unit;
recognizing the received scattered light as a shadow zone;
sending a change in position of the shadow zone to an analysis unit;
analyzing the change in position of the shadow zone; and
determining the orientation and eccentricity of the substrate based on the change of position of the shadow zone.

19. The method of claim 18, wherein the light receiving surface is disposed to form a 90° angle with the illuminating light.

20. The method of claim 18, wherein a reflective member reflects the illumination light onto the light receiving surface.
